(19) United States
(12) Patent Application Publication
(10) Pub. No.: US 2013/0067578 A1
(43) Pub. Date: Mar. 14, 2013

(54) Malware Risk Scanner

(71) Applicants: Jamie Dool, Kitchener (CA); Vishnu Varadaraj, Waterloo (CA); David Karl Juche, Waterloo (CA)

(72) Inventors: Jamie Dool, Kitchener (CA); Vishnu Varadaraj, Waterloo (CA); David Karl Juche, Waterloo (CA)

(73) Assignee: McAfee, Inc., Santa Clara, CA (US)

(21) Appl. No.: 13/227,616

(22) Filed: Sep. 8, 2011

(51) Int. Cl. G06F 11/00; G06F 9/445

(52) U.S. Cl. 726/24

(57) ABSTRACT

A technique for improving the installation of anti-malware software performs an analysis of a computer on which anti-malware software is to be installed prior to complete installation of the anti-malware software. If the analysis determines that the computer may already contain malware, then an attempt may be made to scan and clean the computer prior to the installation of a portion of the anti-malware software. Otherwise, the pre-installation scan and clean may be bypassed, allowing the installation of that portion of the anti-malware software.

### BACKGROUND

This disclosure relates generally to the field of malware detection computer software. More particularly, but not by way of limitation, it relates to an improved installation technique for malware detection, repair, and prevention computer software.

Malware is a broad term used to describe malicious software that infects computer systems. Malware can have varying degrees of effects, ranging from merely irritating to destructive. Malware includes software such as adware and spyware, as well as computer viruses, worms, and Trojan horses. With the vast number of devices connected to networks such as the Internet and the expansion of high speed connections to these networks, malware threats can spread from system to system extremely rapidly. Computer users are therefore commonly urged to employ some type of anti-malware applications, such as anti-virus software on their devices to detect and remove malware that may be installed on the device, as well as to prevent the future installation of malware.

Some customers purchase anti-malware software to clean an already infected computer. Malware already present on the computer is known to attack and in many cases prevent the installation of the anti-malware software or make the installation ineffective. To counter this, some malware detection software has performed a pre-install scan and cleaning of the system by the anti-malware software installer to attempt to ensure a successful install. However, this scan increases the initial download size and can also significantly impact the time to install the anti-malware software, providing a less then optimal installation experience.

### BRIEF DESCRIPTION OF THE DRAWINGS

FIG. 1 is a block diagram illustrating a network architecture according to one embodiment.

FIG. 2 is a block diagram illustrating a computer on which software according to one embodiment may be installed.

FIG. 3 is a block diagram illustrating an anti-malware software installation package according to one embodiment.

FIG. 4 is a flowchart illustrating a technique for installing anti-malware software according to one embodiment.

FIG. 5 is a flowchart illustrating one embodiment of the technique of FIG. 4 in greater detail.

### DETAILED DESCRIPTION

Various embodiments described in more detail below provide a technique for performing an analysis of a computer on which anti-malware software is to be installed prior to complete installation of the anti-malware software. If the analysis determines that the computer may already contain malware, then an attempt may be made to scan and clean the computer prior to a portion of the installation of the anti-malware software. Otherwise, the pre-installation scan and clean may be bypassed, allowing the installation of that portion of the anti-malware software.

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

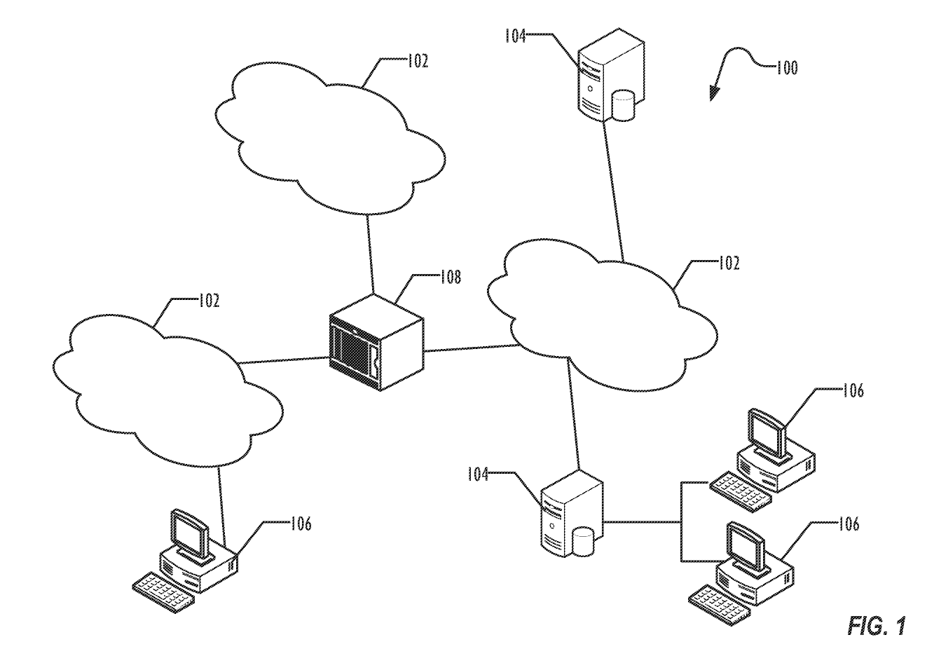

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, etc.

Coupled to the networks 102 are data server computers 104 which are capable of communicating over the networks 102. Also coupled to the networks 102 and the data server computers 104 is a plurality of end user computers 106. Such data server computers 104 and/or client computers 106 may each include a desktop computer, lap-top computer, hand-held computer, mobile phone, hand-held computer, peripheral (e.g. printer, etc.), any component of a computer, and/or any other type of logic. In order to facilitate communication among the networks 102, at least one gateway or router 108 is optionally coupled therebetween.

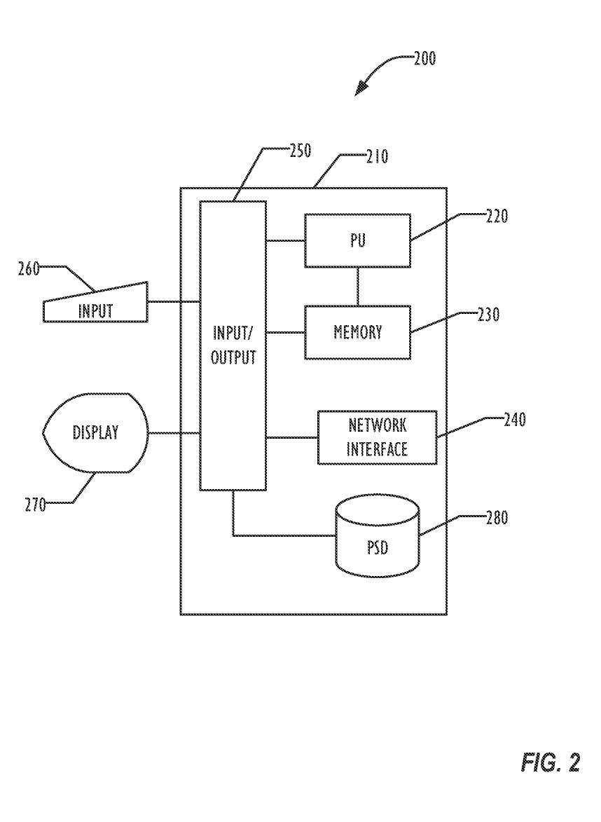

Referring now to FIG. 2, an example computer FIG. 200 for use in providing an anti-malware software installation technique according to one embodiment is illustrated in block diagram form. The computer 200 may serve as a client computer 106 or a server computer 104. Example computer FIG. 200 comprises a system unit FIG. 210 which may be optionally connected to an input device or system FIG. 260 (e.g., keyboard, mouse, touch screen, etc.) and display FIG. 270. A program storage device (PSD) FIG. 280 (sometimes referred to as a hard disc) is included with the system unit FIG. 210. Also included with system unit FIG. 210 is a network interface FIG. 240 for communication via a network with other computing and corporate infrastructure devices (not shown). Network interface FIG. 240 may be included within system unit FIG. 210 or be external to system unit FIG. 210. In either case, system unit FIG. 210 will be communicatively coupled to network interface FIG. 240. Program storage device FIG. 280 represents any form of non-volatile storage including, but not limited to, all forms of optical and magnetic, including solid-state, storage elements, including removable media, and may be included within system unit FIG. 210 or be external to system unit FIG. 210. Program storage device FIG. 280 may be used for storage of software to control system unit FIG. 210, data for use by the computer FIG. 200, or both.

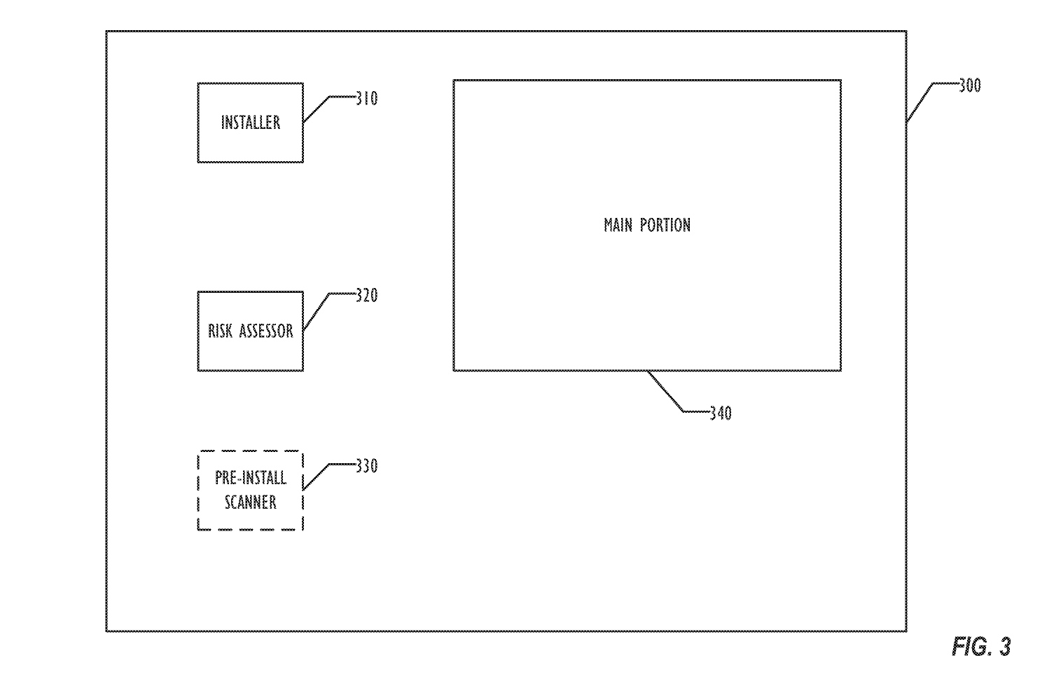

System unit FIG. 210 may be programmed to perform methods in accordance with this disclosure (an example of which is in FIG. 3). System unit FIG. 210 comprises a processor unit (PU) FIG. 220, input-output (I/O) interface FIG. 250 and memory FIG. 230. Processing unit FIG. 220 may include any programmable controller device including, for example, one or more members of the Intel Atom®, Core®, Pentium® and Celeron® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company.) Memory FIG. 230 may include one or more memory modules and comprise random access memory (RAM), read only memory (ROM), programmable read only memory (PROM), programmable read-write memory, and solid-state memory. The PU FIG. 220 may also include some internal memory including, for example, cache memory.

The computer 200 may have resident thereon any desired operating system. Embodiments may be implemented using any desired programming languages, and may be implemented as one or more executable programs, which may link to external libraries of executable routines that may be provided by the provider of the anti-malware software, the provider of the operating system, or any other desired provider of suitable library routines.

In preparation for installing the anti-malware software on the computer 200, embodiments may be provided stored on any type of non-transitory computer-readable media, or may be downloaded from a server 104 onto the program storage device 280.

FIG. 3 Is a block diagram illustrating an anti-malware software installation package 300 according to one embodiment. Installer 310 generally performs the functionality of installing the anti-malware software, including launching the risk assessor 320 and the pre-install scanner 330, in addition to basic install functionality. Risk assessor 320 generally performs an assessment whether the computer 200 on which the anti-malware software is to be installed is in a risky state because of the potential presence of malware on the computer 200. Pre-install scanner 330 generally performs the functionality of a pre-installation scan of the computer 200, as well as any cleaning actions that the pre-install scan determines should be performed. A main portion 340 comprises the packaged routines that once installed will perform the functionality of the anti-malware software. The package 300 may be provided on computer media such as an optical disc as part of a retail package for the anti-malware software. Alternately, the package 300 may be downloaded from a provider of the anti-malware software without the provision of a physical media.

In one embodiment, the pre-install scanner 330, although illustrated as part of the package 300 in FIG. 3, may be omitted from the package 300 as it is initially provided to the computer user. In such an embodiment, the installer 310, upon receiving a result from the risk assessor 320 that the computer 200 is in a risky state, may obtain the pre-install scanner 330 from an external server, then launch the pre-install scanner 330 as described below. Thus, in such an embodiment, the size of the install package 300 may be reduced, because the pre-install scanner 330 does not need to be provided unless the risk assessor has concluded that the computer 200 is in a risky state that requires a pre-install scan.

In other embodiments, the pre-install scanner 330 may be provided as part of the package 300 initially, and may be launched without the need to download the pre-install scanner 330.

Any portion of the package 300, including the risk assessor 320, the pre-install scanner 330, and the main portion 340, may be downloaded by execution of the installer 310 as desired. The package 300 may include components other than those illustrated in FIG. 3, and the illustration of the installer 310, risk assessor 320, pre-install scanner 330, and main portion 340 separately in FIG. 3 should not be understood to imply any particular form or packaging of those portions of the package 300. Any of the features illustrated in FIG. 3 may be combined with any of the other features of the package 300 as desired.

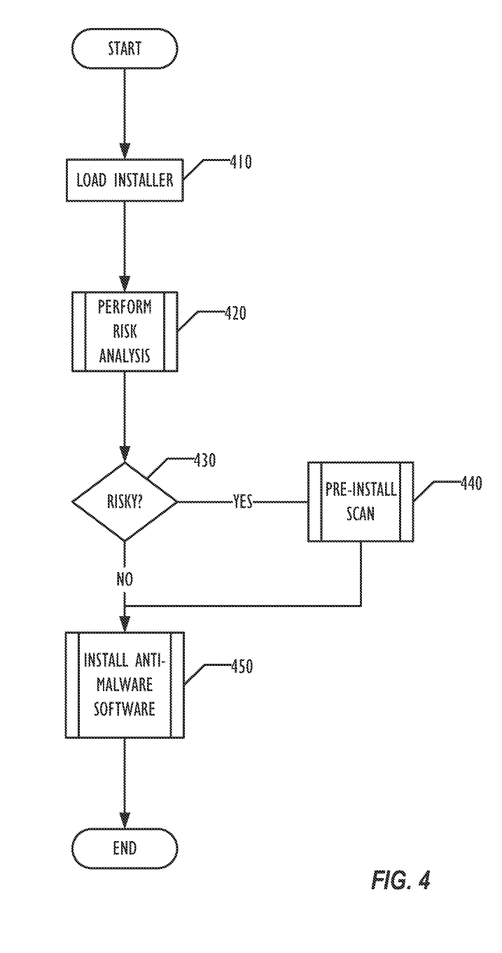

FIG. 4 is a flowchart illustrating a technique for installing anti-malware software according to one embodiment. In block 410, the installer 310 is loaded into memory and begins execution. The installer 310 launches the risk assessor 320 which performs risk analysis on the computer 200 in block 420. If the risk analysis produces a result indicating that the computer 200 is in a risky state because of the presence of malware on the computer 200, as determined in block 430, then the installer 310 may load the pre-install scanner 330, which performs a pre-install scan and clean operation in block 440.

If the determination in block 430 is that the computer is not in a risky state or following completion of the pre-install scan in block 440, the installer 310 completes the installation process of the anti-malware software in block 450.

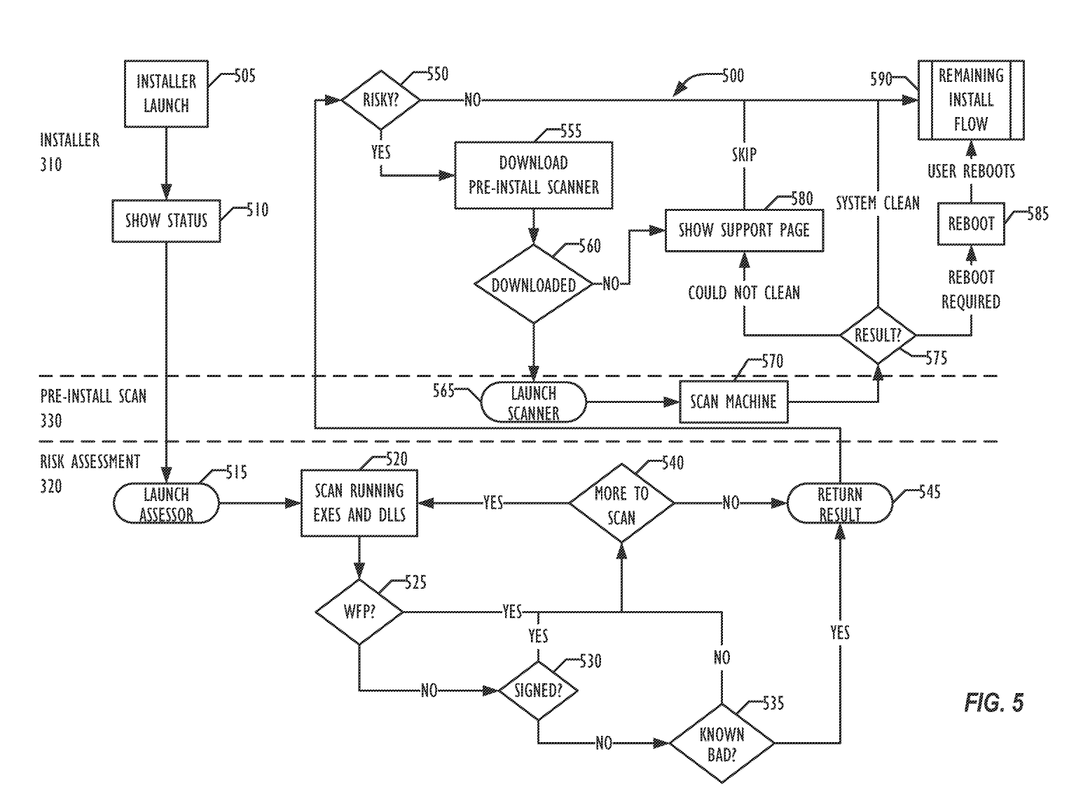

FIG. 5 is a flowchart illustrating one embodiment of a technique for installing anti-malware software in greater detail. The technique as illustrated in FIG. 5 comprises three general sections, corresponding to the installer 310, pre-install scanner 330, and risk assessor 320.

Beginning in block 505, the installer 310 for the anti-malware software is launched. The installer 310 may be provided by the provider of the anti-malware software, and may include routines provided by a vendor of the operating system that are generic to installation processes and may be used by multiple install programs.

In one embodiment, the status of the installation may be displayed for a user of the computer 200 in block 510. This status typically tells the user that the installation of the software has begun, and may provide status information regarding the progress of the installation that is updated from time to time; however, any desired status information may be provided, and the display of status information may be omitted if desired.

The installer then launches the risk assessor 320 in block 515. Some malware software is known to look for the execution of anti-malware software installers or other anti-malware software, triggering an attack upon the anti-malware software based on the name of the executable program. Therefore, in one embodiment, the risk assessor 320 may be named in such a way as to trigger the execution of such malware. For example, a risk assessor 320 provided by McAfee, Inc., the assignee of the present application, may be provided with a name that includes “mcafee” as part of the name of the executable.

The risk assessor 320 in block 520 may use any desired technique for determining the identity of software routines executing on the computer 200. These software routines may include any type of executable routine, including dynamic link libraries. Each of the routines that is executing on the computer 200 may be evaluated for the risk of it being malware.

In one embodiment, a three-step technique may be used for the risk assessment. In block 525, the risk assessor determines whether the executing routine is a protected executable. For example, some versions of the Microsoft WINDOWS® operating system (“WINDOWS” is a registered trademark of Microsoft Corporation) provide a Windows File Protection (WFP) feature that protects programs from replacing critical Windows system files. WFP protects critical system files that are installed as part of Windows (for example, files with a .dll, .exe, .ocx, and .sys extension, using file signatures and catalog files that are generated by code signing to verify if the protected system files are the correct Microsoft versions. The Windows operating system restores the original file if the file is changed by an unauthorized technique. Other operating systems may provide similar types of techniques for protecting critical executables. If the executing routine is a protected executable, then the risk assessor 320 may determine that the executable is safe and would not require a pre-install scan and clean operation.

If the executable is not a protected executable, then in block 530 the risk assessor 320 may determine whether the executable has been digitally signed. Digitally signed routines are generally considered to come from a legitimate company, because of the verification required by the provider of the digital signature certificate, and thus may not require a pre-install scan and clean operation.

If the executable is neither a protected executable nor digitally signed, then in one embodiment in block 535 the risk assessor 320 may send a query to an external system, providing information about the executable program to allow the external system to identify the executable and respond back to the risk assessor 320. The external system may perform a lookup based on the information provided by the risk assessor 320 in a repository of information about executable programs available to the external system, responding with an indication whether the executable is known to be malware. For example, if the computer 200 being scanned is one of the clients 106 illustrated in FIG. 1, the external system may be provided by one of the servers 104 also illustrated in FIG. 1.

If the running executable is protected or is signed, or if the external system indicates that the running executable is not known to be malware, then that executable may be ignored and in block 540 the risk assessor 320 determines whether any additional executables remain to be scanned, repeating beginning in block 520 if any such additional executables remain until all running executables have been scanned.

If the external system responds indicating that a running executable is known to be malware, or if the determination in block 540 is that no more executables remain to be scanned, then a result is returned to the installer in block 545. If the external system responds with an indication that the running executable is known to be malware, then the result returned by the risk assessor 320 may indicate that there is a risk of installing the anti-malware software without performing a pre-install scan and clean operation.

In one embodiment, if the external system is unreachable or for any reason fails to return a response to the query from the risk assessor 320, the risk assessor 320 may decide the running executable may be malware and return a result requesting a pre-install scan and clean operation. If all of the running executables are analyzed and no malware is detected, then the result returned by the risk assessor 320 may indicate that the pre-install scan and clean operation may be skipped.

The techniques described above for determining whether a running executable is malware are illustrative and by way of example only, and other desired techniques may be used in combination with the techniques described above, or in addition to those techniques. For example, other steps may be included to attempt to find rootkits. A rootkit is software that enables continued privileged access to a computer while actively hiding its presence from administrators by subverting standard operating system functionality or other applications.

In addition, some embodiments may provide risk assessment techniques that are tailored to specific types of malware, such as malware types that are particularly aggressive at attempting to hide themselves from and interfering with anti-malware software. In one embodiment a specific check for executables related to a type of malware identified by some portions of the anti-malware industry as “klez” may be included as one of the checks performed by the risk assessment program. In one embodiment, a specific check for executables related to a type of malware identified by some portions of the anti-malware industry as “sality” may be included as one of the checks performed by the risk assessment program. These type-specific risk assessment techniques may be included in addition to or instead of the three techniques described above.

In one embodiment, a risk assessor 320 employing multiple risk assessment techniques, such as illustrated in FIG. 5, preferably orders the execution of the risk assessment techniques so that the techniques are performed with the quickest technique performed first, and other techniques following in order of quickness, so that the technique that takes the longest to perform is performed last. Alternately, a risk assessor 320 employing multiple risk assessment techniques may perform those techniques in parallel as desired.

In one embodiment, instead of employing local techniques such as the protected file and digital signature techniques of block 525 and 530, the risk assessor 320 may employ only online techniques such as is illustrated in block 535. In another embodiment, the risk assessor 320 may employ only local techniques, and not use a technique requiring access to an external system.

In one embodiment, the digital signature technique of block 530 may perform additional testing in addition to checking for the presence or absence of a digital signature. For example, the digital signature technique of block 530 may evaluate the trustworthiness of the digital signature by looking for well-known names in the digital signature, or by evaluating the reputation of the certification authority that provided the digital signature.

Once the risk assessment has been performed by the risk assessor 320, the result is returned to the installer 310 which evaluates in block 550 whether the computer 200 is considered to be in a risky state. If the determination is that the computer 200 is not in a risky state, then the pre-install scan operation may be omitted, reducing the time required for the installation of the anti-malware software. In such a situation, the installer 310 may simply proceed in block 590 with the remainder of the installation process.

If the determination is that the computer 200 is in a risky state, then in block 355 the pre-install scanner 330 may be downloaded from an external system in block 555, if it is not already part of the installation package 300. The external system is typically provided by the provider of the anti-malware software and is typically a server such as one of the servers 104 illustrated in FIG. 1, accessible through a network connection from the computer 200.

In one embodiment, the installer 310 may detect in block 550 a situation where the risk assessor 320 fails to return any result. This may indicate a failure of the risk assessor 320, but also may indicate a scenario in which malware already existing on the computer 200 detected and terminated the risk assessor 320, such as by recognizing the name of the risk assessor 320 as described above. In such an embodiment, the installer 310 may consider a failure of the risk assessor 320 to return any result as an indication that the computer 200 is in a risky state, just as if the risk assessor 320 had returned a result indicating such a risky state.

In block 560, a determination is made whether the download of the pre-install scanner 330 succeeded. If not, then in block 580, a user interface for the installer 310 may display an indication of the failure to download the pre-install scanner 330. The indication displayed by block 580 may be a window generated by the installer 310, a support page displayed by a browser that is linked to from the installer 310, or may be displayed by any other desired technique. Once the indication is displayed in block 580, then the pre-install scan and clean operation may be skipped and the installer 310 proceeds in block 582 install the main portion 340 of the anti-malware software.

If the pre-install scanner 330 successfully downloads, or has previously been loaded onto the computer 200, then the installer 310 launches the pre-install scanner 330 in block 565. The pre-install scanner 330 may then scan the computer 200 in block 570 and take any cleaning actions that are considered necessary as a result of the scan.

In one embodiment, the scan performed in block 570 may be a modified version of the scan that would be performed by the anti-malware software after it is installed. Some types of malware that may be scanned during normal operation of the anti-malware software may be omitted from the pre-install scan of block 570 if the type of malware is deemed unlikely to cause problems during the installation process. For example, some anti-malware software attempts to locate and remove spyware, which typically collects small pieces of information about users without their knowledge. Spyware software may not affect the installation process of the anti-malware software and in one embodiment the pre-install scanner 330 may be configured to ignore spyware during the pre-install scan of block 570. Other types of malware that are considered unlikely to affect the installation process may similarly be omitted, allowing the pre-install scan to be performed quicker and with less overhead than a post-install scan of the computer 200 by the anti-malware software.

The pre-install scan performed in block 570 may make use of an information resource, sometimes referred to as a DAT file, that contains information useful for detecting and removing malware. Alternately, or in addition to the local information resource, the pre-install scan performed by the pre-install scanner 330 in block 570 may request assistance from an external resource, such as may be provided by one of the servers 104, for the purpose of identifying malware that may be present on the computer 200. The DAT file may be downloaded as part of the pre-install scanner 330 in block 555, or may be provided as part of the anti-malware installation package 300 as desired. Alternately, the DAT file may be downloaded by the pre-install scanner 330 as part of launching the pre-install scanner 330. In one embodiment, the pre-install scan of block 570 uses only the services of the external resource for the identification of malware on the computer 200 and does not use a local DAT file for that purpose.

In addition to identifying malware already present on the computer 200, the pre-install scan performed in block 570 may take indicated cleaning actions as may be necessary to remove detected malware from the computer 200 prior to the installation of the anti-malware software. In some situations, cleaning actions may require a reboot of the computer 200, in which case the pre-install scanner 330 may provide an indication that a reboot is required as part of the results provided to the installer 310 upon completion of the pre-install scan and clean operation performed in block 570.

In block 575, the installer 310 examines an indication of the results of the pre-install scan and clean operation returned by the pre-install scanner 330. In one embodiment, three types of results may be returned by the pre-install scanner 330. In a first type of result, the pre-install scanner 330 may indicate that the scan and clean operation was successful, but a reboot of the computer 200 is required before completion of the installation process. In a second type of result, the pre-install scanner 330 may indicate that the computer 200 has been successfully cleaned. In a third type of result, the pre-install scanner 330 may indicate that the pre-install scanner 330 was unsuccessful in cleaning the computer 200.

If the installer 310 receives a result from the pre-install scanner 330 indicating that the computer 200 could not be cleaned, then in one embodiment the installer 310 may display an indication in block 580 that the computer 200 could not be cleaned by the pre-install scanner 330. In one embodiment, the installer 310 may proceed with the installation of the main portion 340 of the anti-malware software 300 in block 590 even though there may be a risk that the installation process may have problems because of the pre-existing malware that could not be cleaned from the computer 200. In another embodiment, the installer 310 may allow a user to decide whether or not to proceed with the remainder of the installation of the anti-malware software. In yet another embodiment, the installer 310 may refuse to continue the installation and exit.

If the installer 310 receives a result from the pre-install scanner 330 indicating that the computer 200 is clean, then the installer 310 may proceed with the remaining portions of the installation process in block 590, installing the main portion 340 of the anti-malware software installation package 300.

If the installer 310 receives result from the pre-install scanner 330 indicating that a reboot is required, then in one embodiment in block 585 a user of the computer 200 may be offered an opportunity to reboot the computer 200. In another embodiment, the installer 310 may cause a reboot of the computer 200 without asking permission from the user. In either embodiment, once the computer 200 is rebooted, then the installer 310 may complete the installation process, installing the main portion 340 of the installation package 300.

By performing a pre-install scan and clean operation only when necessary, embodiments described above can speed up the process of installing anti-malware software without risking a failed or incompletely operative installation of the anti-malware software. The improved anti-malware installation process may encourage computer users to install the anti-malware software who otherwise might choose not to install the anti-malware software. Because the usage of unprotected computers allows malware to infect and possibly take over operation of unprotected computers, the improved installation techniques described above may benefit not only the user of the computer 200 but users of other computers in the network architecture 100.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method comprising:
launching an installer for an anti-malware software on a first computer;
performing a risk assessment of the first computer;
performing a pre-install scan and clean operation on the first computer by a pre-install scanner responsive to a result of the risk assessment indicating that the computer is in a risky state; and
installing a main portion of the anti-malware software responsive to the pre-install scan and clean operation.

2. The method of claim 1, wherein the act of performing a risk assessment of the first computer comprises:
indicating that the first computer is in a risky state if malware is detected on the first computer.

3. The method of claim 1,
wherein the act of performing a risk assessment of the computer comprises:
launching a risk assessor software by the installer.

4. The method of claim 3, wherein the result of the risk assessment indicating that the computer is in a risky state comprises a failure by the risk assessor software to return any result.

5. The method of claim 1, further comprising:
downloading the pre-install scanner from a second computer, responsive to the risk assessment.

6. The method of claim 5, further comprising:
providing an indication that the pre-install scanner did not successfully download; and
omitting the performance of the act of performing a pre-install scanning clean operation on the first computer.

7. The method of claim 1, wherein the act of installing a main portion of the anti-malware software responsive to the pre-install scan and clean operation comprises:
indicating that the pre-install scanner did not succeed in cleaning the first computer of malware discovered by the pre-install scanner.

8. The method of claim 7, further comprising:
asking a user of the first computer whether to attempt to perform the act of installing a main portion of the anti-malware software if the pre-install scanning clean operation did not succeed in cleaning the first computer.

9. The method of claim 1, wherein the act of installing a main portion of the anti-malware software responsive to the pre-install scan and clean operation comprises:
requesting a user of the first computer to reboot the first computer; and
installing a main portion of the anti-malware software after rebooting the first computer.

10. The method of claim 1, wherein the act of performing a pre-install scan and clean operation on the first computer by a pre-install scanner responsive to a result of the risk assessment indicating that the computer is in a risky state comprises:
ignoring a first malware, wherein the first malware is known not to impact installation of the anti-malware software.

11. The method of claim 1, wherein the act of performing a risk assessment of the first computer comprises:
performing a plurality of checks on each executable running on the first computer; and
determining whether the first computers in a risky state responsive to the plurality of checks.

12. The method of claim 11, wherein the act of performing a risk assessment of the first computer further comprises:
ordering the plurality of checks so that a quickest of the plurality of checks is performed first.

13. The method of claim 11, wherein one of the plurality of checks comprises:
determining whether an executable is an operating system protected file.

14. The method of claim 11, wherein one of the plurality of checks comprises:
determining whether an executable is digitally signed.

15. The method of claim 11, wherein one of the plurality of checks comprises:
requesting information about an executable from an external system, wherein the external system responds with an indication of whether the executable is known to be malware.

16. A non-transitory computer readable medium with instructions for a programmable control device stored thereon wherein the instructions cause a programmable control device to perform actions comprising:
launching an installer for an anti-malware software on a first computer;
performing a risk assessment of the first computer;
performing a pre-install scan and clean operation on the first computer by a pre-install scanner responsive to a result of the risk assessment indicating that the computer is in a risky state; and
installing a main portion of the anti-malware software responsive to the pre-install scan and clean operation.

17. A server computer, comprising:
a processor; and
a storage subsystem, coupled to the processor, on which is stored instructions that when executed by the processor, cause the processor to perform actions, comprising:
receive a request for a pre-install scanner software from a client computer attempting to install an anti-malware software determined to be in a risky state;
send the pre-install scanner software to the client computer for execution prior to installing a portion of the anti-malware software,
wherein the pre-install scanner comprises instructions that when executed by the client computer, cause the client computer to perform actions comprising:
scanning the client computer for malware installed on the client computer; and
cleaning the client computer of malware discovered by performing the act of scanning the client computer for malware installed on the client computer.

18. The server computer of claim 17, wherein the act of scanning the client computer for malware installed on the client computer comprises
ignoring malware known not to impact installation of the anti-malware software on the client computer.

19. The server computer of claim 17, wherein the pre-install scanner comprises:
a scanning engine; and
an information resource, comprising:
information corresponding to a known malware for use in detecting the malware on the client computer; and
information corresponding to the known malware for use in cleaning the malware from the client computer.

20. The server computer of claim 17, wherein the pre-install scanner comprises instructions that when executed by the client computer, cause the client computer to perform actions further comprising:
indicating to an installer program on the client computer whether the act of cleaning the client computer of malware succeeded.
